(19) United States
(12) Patent Application Publication
(10) Pub. No.: US 2012/0042495 A1
(43) Pub. Date: Feb. 23, 2012

(54) SHORING POST WITH QUICK RELEASE FEATURE

(76) Inventor: David L. Bacon, Tempa, AZ (US)

(21) Appl. No.: 13/215,773

(22) Filed: Aug. 23, 2011

Related U.S. Application Data
(60) Provisional application No. 61/376,036, filed on Aug. 23, 2010.

(51) Int. Cl. B23P 11/00; E04G 25/04

(52) U.S. Cl. 29/428; 248/354.5

(57) ABSTRACT

A shoring post having first and second post parts that cooperatively define a variable effective length, a quick release assembly, and a movable pin that in an operative position limits movement of the first post part in one lengthwise direction relative to the second post part. The quick release assembly has: a) at least a first surface against which the pin bears with the pin and quick release assembly in a first operative relationship; and b) at least a second surface against which the pin bears with the pin and quick release assembly in a second operative relationship. The shoring post further has at least one repositionable member that is changeable selectively between: a) a locked state to prevent the pin and quick release assembly from changing from the first operative relationship into the second operative relationship; and b) a released state.

### BACKGROUND OF THE INVENTION

1. Field of the Invention

This invention relates to shoring posts and, more particularly, to a shoring post that can be reconfigured to instantaneously reduce compressive loading thereupon.

2. Background Art

Shoring posts are used in many industries and commonly in the construction field as formwork components. A typical shoring post has telescoping parts that can be releasably maintained in a desired relationship using a pin. In one exemplary construction, an upper post part slides within a lower post part and has through openings at regularly spaced vertical intervals. By directing a pin through one of the openings, diametrically opposite portions of the pin will bear upon the lower post part to maintain the overall nominally desired length of the post. One or more threaded components allow additional controlled length extension, thereby to effectively load the shoring post in compression between facing surfaces, commonly on a subjacent floor and an overhead beam. The threaded component may be in the form of a jack on the upper post part that is turned in opposite directions to selectively move an associated bearing plate upwardly and downwardly. In an alternative form, an extension sleeve is threadably engaged with the bottom post part and is borne upon by the aforementioned pin extending through the selected opening in the upper post part. Turning of the extension sleeve causes the sleeve to move upwardly or downwardly, depending upon the direction of turning, with the former causing the effective length of the shoring post to increase.

Once the shoring post is installed, it is typically under considerable compression. In the event that a shoring post is required to be reset or removed during, or at the conclusion of, a project, the compressive force must be released before the shoring post can be separated or disassembled. One option for releasing the compressive force is to reverse the last steps that placed the shoring post in compression. That is, the threaded jack component or extension sleeve might be turned reversely to thereby reduce the effective overall length of the shoring post.

Alternatively, and in the interest of saving time and minimizing user fatigue, it is known to incorporate a quick release feature whereby a simple step will instantaneously release compressive loading upon the shoring post to allow its resituation or removal.

One exemplary form of quick release mechanism is shown in U.S. Pat. No. 5,310,153 (Jackson). In Jackson, a contoured washer is interposed between the pin in an upper post part and an extension sleeve. By turning the washer relative to the pin in one direction around the vertical axis, the effective length of the shoring post can be progressively increased, whereas turning in the opposite direction shortens the effective length of the shoring post. The pin resides in a pair of diametrically opposite “cradling seats” with the washer in one angular, operative orientation.

While Jackson permits instantaneous reduction of compressive loading upon a shoring post, at least one limitation with this structure is apparent when used in a typical construction environment. On construction sites whereat formwork is in place, it is common for the shoring posts to be abruptly loaded, as when heavy materials are placed or dropped on overlying surfaces supported by the bearing posts. The bearing posts may also be subjected to vibration due to loading or other activities performed at a site. These dynamic forces may instantaneously or progressively cause shoring post components to shift/turn relative to each other. In Jackson, it is conceivable that the components under such forces might relatively move to the point that the pin will move angularly out of the cradling seats, thereby causing the upper post to shift downwardly and reduce the compressive loading.

In the event that the quick release feature permits only a modicum of movement of the upper post part relative to the lower post part, this inadvertent release action might not cause the shoring post to shift to the point that it fails to support the overhead structure that it engages. In any event, the shoring post in the changed state might have to be readjusted to generate the requisite compressive force and/or appropriately position the overlying vertical component that it engages.

In a worst case, the inadvertent reduction in the compressive forces upon the shoring post may result in a significant shifting of the shoring post and/or the structure it supports. This not only represents an inconvenience, but could result in a significant structural failure and, potentially, personal injury to those working at the site.

While the importance of incorporating a quick release feature into a shoring post has been appreciated for decades, the industry has not devised a structure that can be simply operated and will maintain a fixed shoring post length, regardless of the forces that the shoring post may be subjected to. In an industry where safety and efficiency are critical, and often competing objectives, the need for improved shoring post structures remains.

### SUMMARY OF THE INVENTION

In one form, the invention is directed to a shoring post having: first and second post parts that are slidable guidingly relative to each other along a lengthwise line to cooperatively define a variable effective length; a quick release assembly; and a movable pin that is extended into the first post part to an operative position wherein the pin abuts to the quick release assembly to limit movement of the first post part in one lengthwise direction relative to the second post part. The quick release assembly has: a) at least a first surface against which the pin bears with the pin and quick release assembly in a first operative relationship; and b) at least a second surface against which the pin bears with the pin and quick release assembly in a second operative relationship. The first and second surfaces are spaced from each other along the lengthwise line. The shoring post further includes at least one repositionable member that is changeable selectively between: a) a locked state wherein the at least one repositionable member prevents the pin and quick release assembly from changing from the first operative relationship into the second operative relationship; and b) a released state wherein the pin and quick release assembly can be changed from the first operative relationship into the second operative relationship.

In one form, the first and second parts are tubular components that are telescopingly engaged, one within the other.

In one form, the at least one repositionable member is a pin.

In one form, the pin has a “C” shape.

In one form, the pin has a body that moves as one piece. The body has: a) a first leg that extends into the first post part and abuts to the quick release assembly to thereby limit movement of the first post part in the one lengthwise direction relative to the second post part; and b) a second leg that abuts to the quick release assembly with the pin in the locked state to thereby prevent the pin and quick release member from changing from the first operative relationship into the second operative relationship.

In one form, the first leg has a length with a central axis and the pin is changed between the locked and released states by moving around the central axis of the first leg.

In one form, the at least first and second surfaces are substantially flat and reside in planes that are substantially parallel to each other and orthogonal to the lengthwise line.

In one form, the shoring post has a central axis parallel to the lengthwise line and the quick release assembly has a body that is movable as one piece relative to the first and second post parts around the central axis of the shoring post.

In one form, the body defines the first surface and a diametrically opposite surface and the pin bears against both the first and diametrically opposite surfaces with the pin and quick release assembly in the first operative relationship.

In one form, the body defines the second surface and a diametrically opposite surface and the pin bears against both the second and diametrically opposite surfaces with the pin and quick release assembly in the second operative relationship.

In one form, the body has a shape that is symmetrical so that the body interacts with the pin in the operative position in the same manner with the body in each of: a) one angular position; and b) a second angular position turned relative to the pin through 180° around the central axis of the shoring post from the one angular position.

In one form, the shoring post has a central axis parallel to the lengthwise line and the quick release assembly has spaced walls bounding the second surface that abut to the pin with the pin and the quick release assembly in the second operative relationship to confine opposite relative angular movement between the first post part and quick release assembly around the central axis.

In one form, the shoring post has a central axis parallel to the lengthwise line and the quick release assembly has a wall that abuts to the pin with the pin and the quick release assembly in the first operative relationship to block angular movement of the first post part in one direction around the central axis relative to the quick release assembly.

In one form, the pin has a body that is movable as one piece and the body abuts to the wall with the pin and the quick release assembly in the first operative relationship and the repositionable member in the locked state to thereby block angular movement of the first post part oppositely to the one direction relative to the quick release assembly.

In one form, the shoring post has a central axis parallel to the lengthwise line and the quick release assembly has a surface with a face to be impacted by a force along a first line and a force imparted to the face along the first line has a component that urges the quick release assembly in movement around the central axis.

In one form, the quick release assembly has a body that moves as one piece around the central axis and the body has a block upon which the face is defined.

In one form, the face projects radially to outside of the first and second post parts.

The invention is further directed to a method of using a shoring post. The method includes the steps of: providing a shoring post as set forth above; with the pin in the released state, placing the shoring post in compression between facing surfaces with the pin and quick release assembly in the first operative relationship; with the pin and quick release assembly in the first operative relationship, changing the pin from the released state into the locked state by turning the pin around the central axis of the first leg; changing the pin from the locked state back into the released state; and changing the pin and quick release assembly from the first operative relationship into the second operative relationship.

In one form, the step of providing a shoring post involves providing a shoring post with a central axis parallel to the lengthwise line and a quick release assembly having a body that is movable around the central axis as one piece.

In one form, the step of changing the pin and quick release assembly from the first operative relationship into the second operative relationship involves producing a sharp impact force upon the body of the quick release assembly that causes the body of the quick release assembly to turn around the central axis.

### BRIEF DESCRIPTION OF THE DRAWINGS

FIG. 1 is a perspective view of a conventional shoring post operatively assembled between vertically spaced surfaces and including joinable first/upper and second/lower post parts and a pin for maintaining a desired relationship between the post parts;

FIG. 2 is an enlarged, perspective view of the upper portion of the shoring post in FIG. 1;

FIG. 3 is an enlarged, exploded, perspective view of the shoring post in FIG. 1;

FIG. 4 is a view as in FIG. 1 of a shoring post, according to the present invention, having a first/upper part, a second/lower part and a pin, and incorporating a quick release assembly;

FIG. 5 is an enlarged, perspective view of the upper portion of the shoring post in FIG. 4;

FIG. 6 is an enlarged, exploded, perspective view of the shoring post in FIG. 4;

FIG. 7 is an enlarged, perspective view of the shoring post in FIG. 4 with the pin and quick release assembly in a first operative relationship and with the pin in a locked state;

FIG. 8 is a view as in FIG. 7 with the pin in a released state and the pin and quick release assembly in a second operative relationship;

FIG. 9 is an enlarged, elevation view of the shoring post in the FIG. 7 state;

FIG. 10 is a view as in FIG. 9 with the shoring post turned through 90° around a vertical axis.

FIG. 11 is a view as in FIG. 10 with the shoring post turned an additional 90°;

FIG. 12 is a view as in FIG. 9 with the shoring post in the FIG. 8 state;

FIG. 13 is a view as in FIG. 12 with the shoring post turned through 90° around the vertical axis;

FIG. 14 is a view as in FIG. 13 with the shoring post turned an additional 90°;

FIG. 15 is an enlarged, perspective view of the pin on the inventive shoring post;

FIG. 16 is an enlarged, top perspective view of the quick release assembly on the inventive shoring post;

FIG. 17 is an enlarged, bottom perspective view of the quick release assembly;

FIG. 18 is an enlarged, plan view of the quick release assembly;

FIG. 19 is an enlarged, elevation view of the quick release assembly;

FIG. 20 is a schematic representation of cooperating post parts usable according to the present invention;

FIG. 21 is a perspective view of a shoring post as in FIG. 4 and with the shoring post in an inverted orientation and incorporating a retainer assembly for the shoring post parts;

FIG. 22 is an enlarged, fragmentary perspective view of a portion of the shoring post in FIG. 21 whereat the retainer assembly is incorporated; and

FIG. 23 is a fragmentary perspective view of a modified form of shoring post with a quick release assembly, according to the present invention, incorporated.

### DETAILED DESCRIPTION OF THE PREFERRED EMBODIMENT

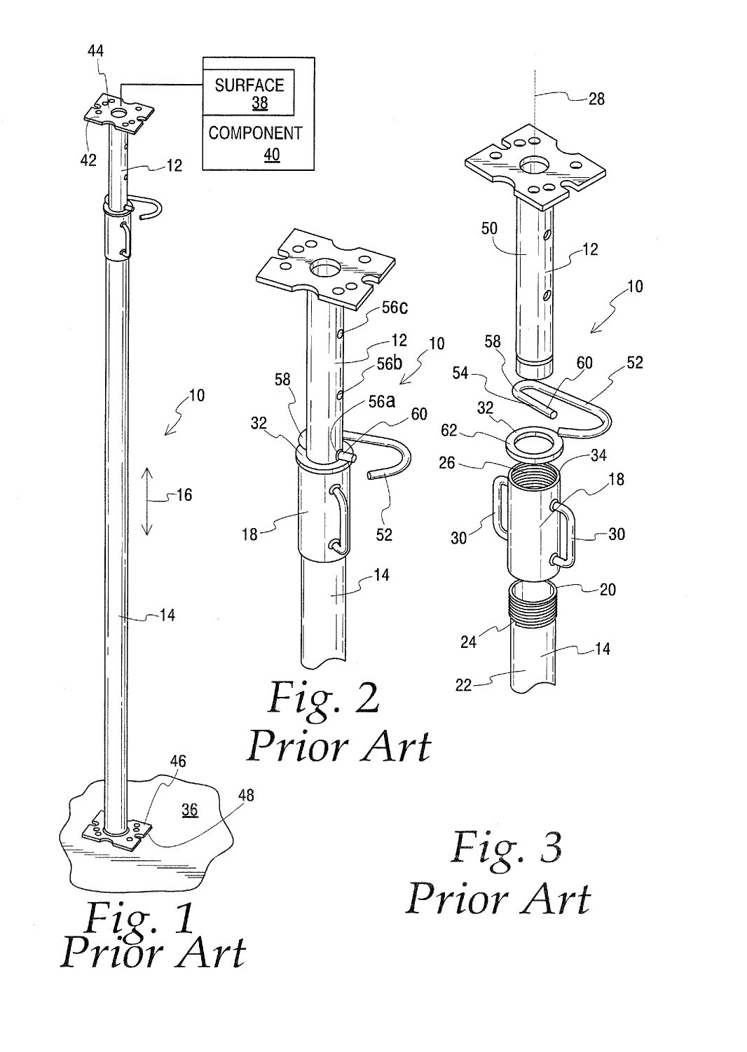

In FIGS. 1-3, a conventional shoring post is shown at 10 with a length adjusting capability. The shoring post 10 consists of a first, upper post part 12 and a second, lower post part 14. The post parts 12, 14 are telescopingly mated to allow the effective overall length of the shoring post 10, as indicated by the double-headed arrow 16, to be selectively varied.

The lower post part 14 includes an extension sleeve 18 that fits over the upper free end 20 of a tubular component 22 making up the post part 14. The tubular component 22 has external threads 24 that engage internal threads 26 on the post part 14. By turning the extension sleeve 18 around a vertical, central axis 28 for the shoring post 10, the extension sleeve 18 can be shifted selectively upwardly and downwardly relative to the component 22, depending upon the turning direction. Handles 30 at diametrically opposite locations on the extension sleeve 18 facilitate grasping and turning of the extension sleeve 18.

A washer 32 surrounds the post part 12 and bears upon the upper edge 34 of the extension sleeve 18.

The shoring post 10 is designed to be loaded in compression in a vertical direction between an underlying surface 36 and a spaced, oppositely facing surface 38 on a component 40 residing above the surface 36—typically a horizontal beam. However, the nature of the component 40 is not critical to the present invention, as it is contemplated that the shoring post 10 might be utilized in any environment in which a vertical compressive support is required, be it in the construction field or elsewhere.

The top of the post part 12 carries a bearing plate 42 with a surface 44 to act against the surface 38 on the component 40. A like bearing plate 46 is provided at the bottom of the component 22 and has a surface 48 to facially engage the underlying surface 36.

To install the shoring post 10, a tubular component 50 on the post part 12 is mated with the tubular component 22 on the post part 14 by placing the components 22, 50, one within the other, to permit sliding guided movement therebetween along a lengthwise line parallel to the central axis 28. The post parts 12, 14 are situated so that their combined length nominally matches, while being slightly less than, the distance between the surfaces 36, 38. Once this relationship is achieved, a C-shaped pin 52 is assembled into an operative position by directing a leg 54 thereon through the one of three vertically spaced openings 56a, 56b, 56c exposed in closest proximity to the washer 32. The leg 54 has sufficient length to project diametrically oppositely from the post part 12 and thereby span across the diameter of the washer 32. Oppositely projecting pin portions 58, 60 bear upon the upper edge 62 of the washer 32 at diametrically opposite locations. The washer 32 in turn bears upon the upper edge 34 of the extension sleeve 18.

The number and vertical spacing of the openings 56a, 56b, 56c dictates the degree of length adjustment permitted and also the incremental length change from one opening to the next. Once the leg 54 has been directed into the appropriate opening to set a gross length adjustment matched to, but slightly less than, the distance between the surfaces 36, 38, the extension sleeve 18 can be turned to increase the effective length of the post part 14 so as to exert a compressive loading force between the surfaces 36, 38.

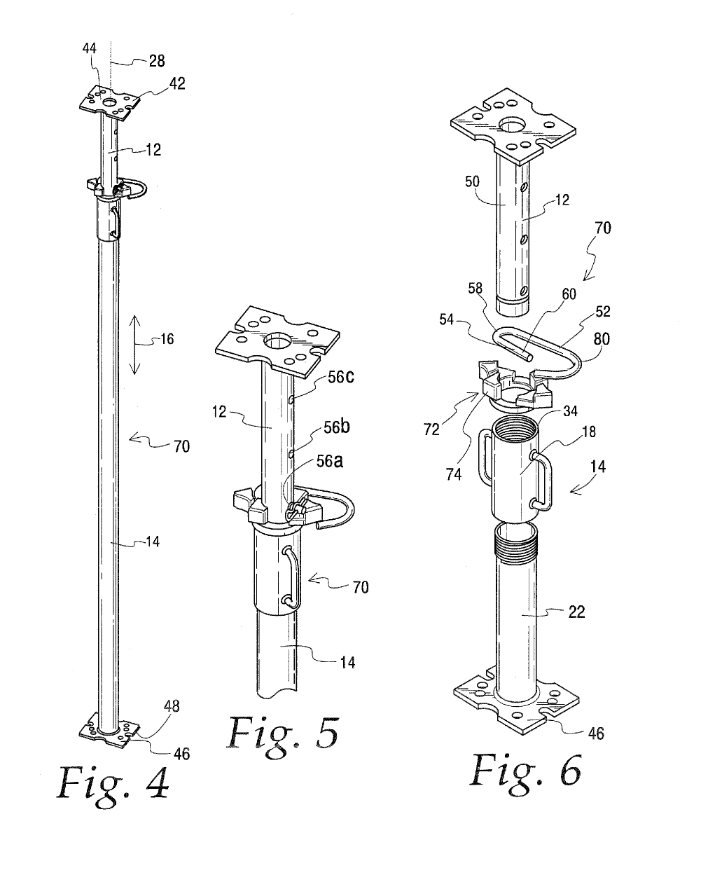

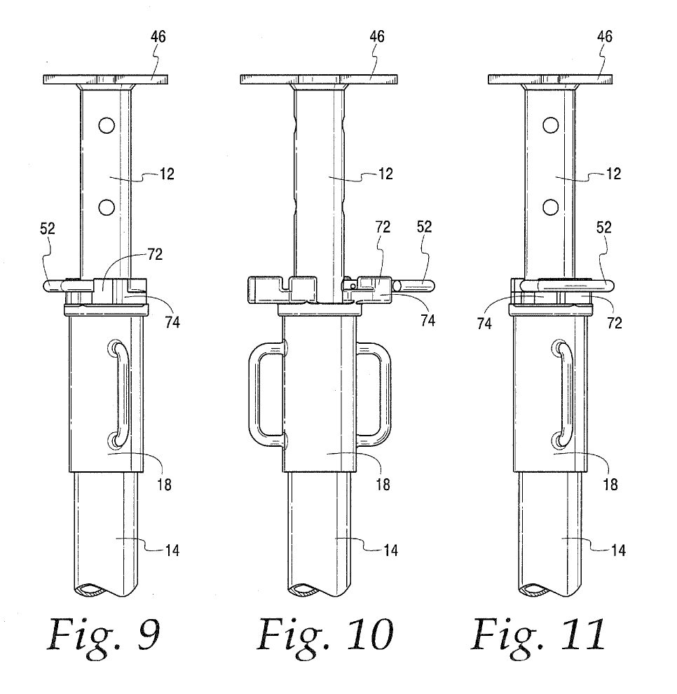

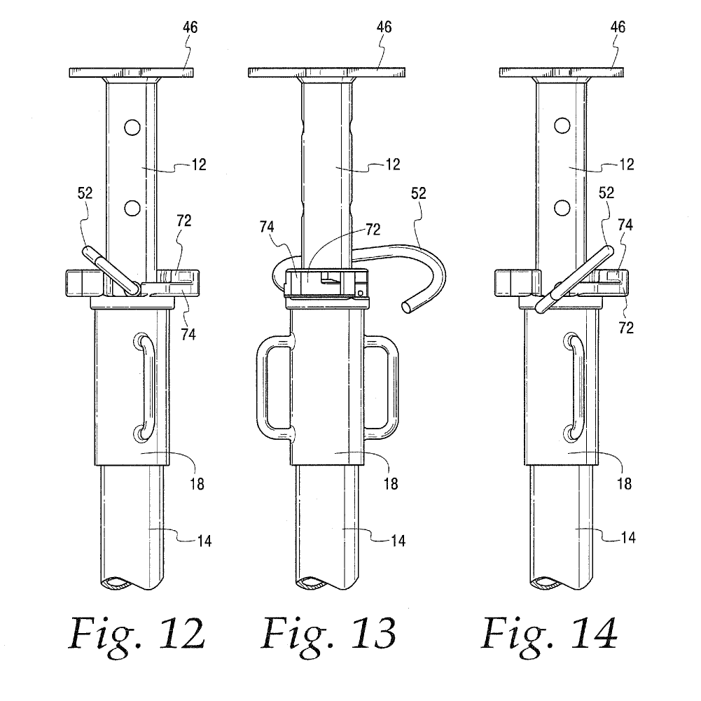

In FIGS. 4-19, a shoring post 70, according to the present invention, is shown. The only difference between the shoring post 10 and the inventive shoring post 70 is that the inventive shoring post 70 has a quick release feature, as hereinafter described in greater detail. Parts on the shoring post 70, corresponding to those shown on the shoring post 10, will be identified with the same reference numerals herein.

As in the prior art shoring post 10, the shoring post 70 has the first and second, upper and lower, post parts 12, 14 that are slidably guidingly relative to each other along the lengthwise line 16, parallel to the central axis 28 of the shoring post 70, to cooperatively define a variable effective length between the surfaces 44, 48 on the bearing plates 42, 46, respectively.

It should be understood that while the post parts 12, 14 are shown to have mating, telescopingly engaged, tubular components 22, 50, the invention contemplates other configurations for the first and second post parts, as shown schematically at 64 and 66 in FIG. 20. FIG. 20 is intended to encompass any cooperating post parts that are guided relative to each other to cooperatively define variable effective lengths.

A quick release assembly 72 substitutes for, or alternatively can be used in conjunction with, the aforementioned washer 32. In the depicted embodiment, the quick release assembly 72 is used by itself without a washer.

The post parts 12, 14 are joined as previously described, with the quick release assembly 72 surrounding the tubular component 50 and abutting the upper edge 34 of the extension sleeve 18. The quick release assembly 72 may be made with one or multiple pieces. In this embodiment, the quick release assembly 72 has a body 74 that moves as one piece relative to each of the post parts 12, 14 around the central axis 28.

With the post parts 12, 14 relatively positioned to produce a desired combined length, the leg 54 is directed through the exposed opening 56a, 56b, 56c closest to the quick release assembly 72. Once the leg 54 on the pin 52 is extended into the post part 12 to an operative position, under the weight of the post part 12, the pin 52 abuts to the quick release assembly 72, thereby to limit movement of the first post part 12 downwardly along the axis 28 relative to the second post part 14. As on the shoring post 10, the pin 52 has portions 58, 60 that project oppositely from the post part 12 to engage the body 74 of the quick release assembly 72 at diametrically opposite locations.

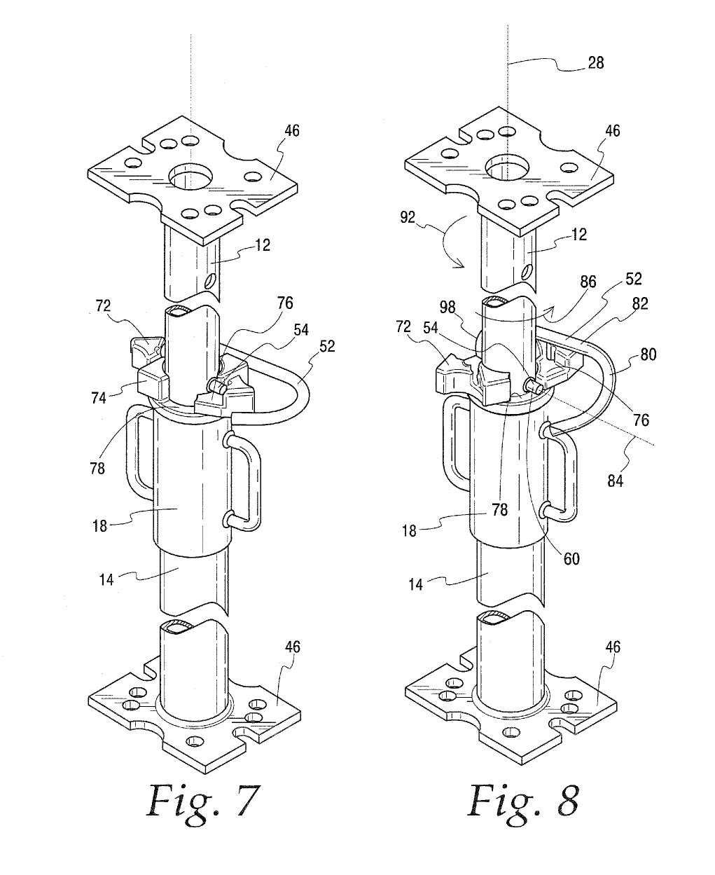

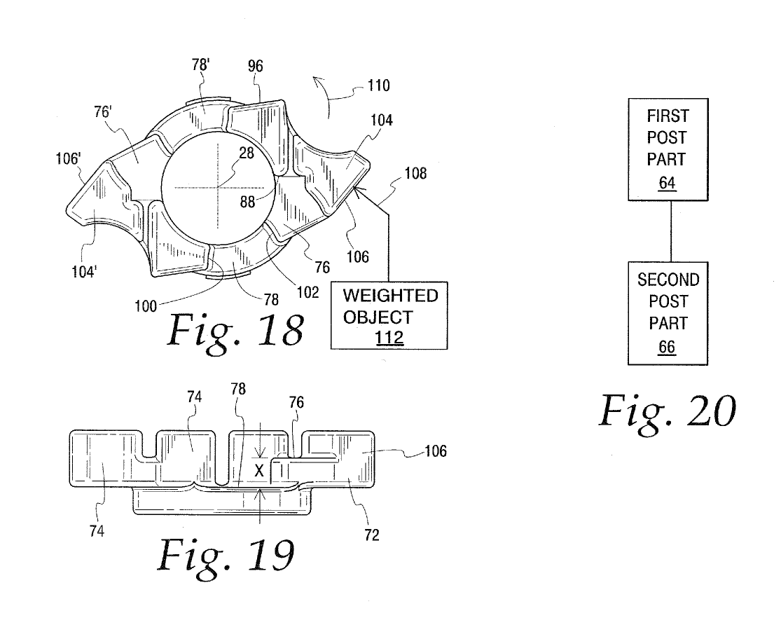

The body 74 has a first surface 76 against which the pin leg 54 bears with the pin 52 and quick release assembly 72 in a first operative relationship, as shown in FIG. 7. A second surface 78 is defined by the body 74 against which the pin 52 bears with the pin 52 and quick release assembly 72 in a second operative relationship, as shown in FIG. 8. The first and second surfaces 76, 78 reside in parallel planes that are spaced from each other a distance X (see FIG. 19) along a lengthwise line parallel to the central shoring post axis 28. The surfaces 76, 78 are shown to be parallel to each other and orthogonal to the axis 28, though this is not required.

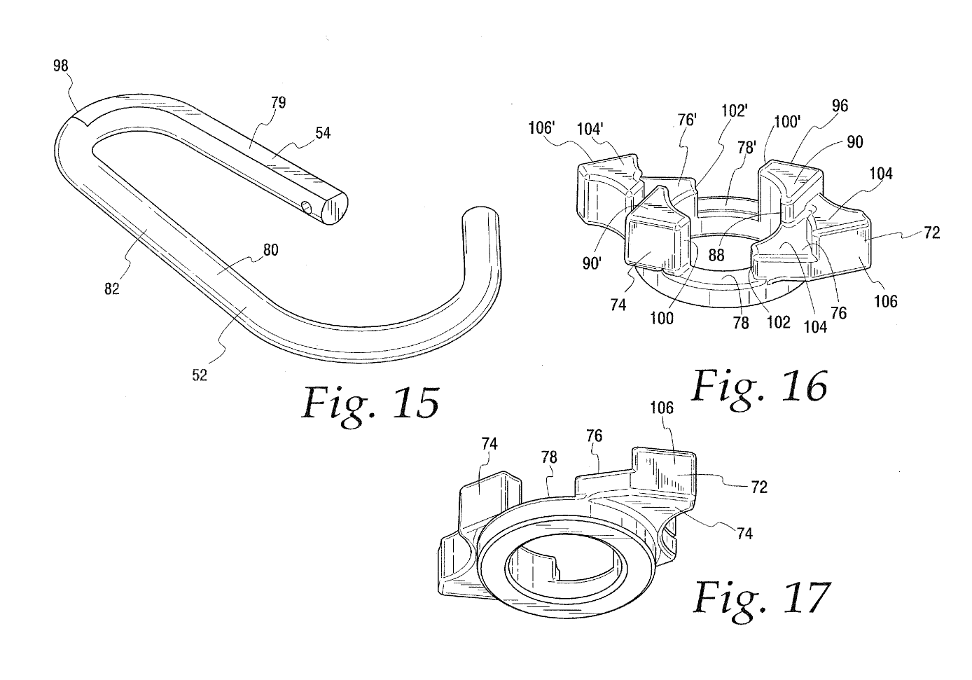

For stability purposes, the pin 52 is made with an optional flat 79 (FIG. 15) on the side thereof that abuts to the quick release assembly 72.

While a single first surface 76 and a single second surface 78 might perform adequately, in a preferred form, the first surface 76 has a diametrically opposite counterpart 76′, with the second surface 78 having a corresponding diametrically opposite surface 78′. The design of the body 74 is such that the pin portions 58, 60 engage one each with the first surfaces 76, 76′ with the pin 52 and quick release assembly 72 in the first operative relationship. The portions 58, 60 engage one each with the second surfaces 78, 78′ with the pin 52 and quick release assembly 72 in the second operative relationship.

The body 74 has a shape that is symmetrical so that the body 74 interacts with the pin 52 in the operative position in the same manner with the body 74 in each of: a) one angular position; and b) a second angular position turned through 180° around the central axis 28 of the shoring post 70 from the one angular position. Thus, depending upon the orientation for the body 74, the portions 58, 60 of the pin leg 54 will engage one or the other of the surfaces 76, 78; 76′, 78′. As a result, to set up the shoring post 70, the installer is not required to turn the body 74 relative to the post part 12 through more than 180° to align the pin 52 over the first surfaces 76, 76′.

The quick release assembly 72 is configured to cooperate with at least one repositionable member that is changeable selectively between: a) a locked state wherein the at least one repositionable member prevents the pin 52 and quick release assembly 72 from changing by relative angular movement around the axis 28 from the first operative relationship into the second operative relationship; and b) a released state wherein the pin 52 and quick release assembly 72 can be changed by relative angular movement around the axis 28 from the first operative relationship into the second operative relationship. While it is contemplated that the at least one repositionable member can be a single component, or multiple components, separate from the pin 52, in this embodiment, the pin 52 defines the at least one repositionable member.

More particularly, the pin 52 has a body 80 that is formed into a “C” shape. The pin body 80, which moves as one piece, and in this case is formed from a single piece of cylindrical stock, consists of: a) the leg 54 that extends into the first post part 12 and abuts to the quick release assembly 72 to thereby limit movement of the first post part 12 in one lengthwise direction relative to the second post part 14; and b) a second leg 82 that abuts to the quick release assembly 72 with the pin 52 in the locked state to thereby prevent the pin 52 and quick release assembly 72 from changing from the first operative relationship of FIG. 7 into the second operative relationship of FIG. 8.

The first leg 54 has a length with a central axis 84. The pin 52 is changed between the locked and released states therefor by moving the body 80 of the pin 52 around the central axis 84 of the first leg 54.

To assembly the shoring post 10, the pin 52 is placed in the released state, as shown in FIGS. 8 and 12-14. The body 80 is angularly oriented so that the pin leg 54 spans across the first surfaces 76, 76′. The pin 52 can then be pivoted around the leg axis 84, thereby to place the pin 52 in its locked state.

The pin portions 58, 60 interact with the body 74 in the same manner at diametrically opposite locations. With the pin 52 in its locked state, the exemplary pin portion 60 is confined to angularly align over the first surface 76. Turning of the post part 12 relative to the body 74 in one direction around the axis 28, as indicated by the arrow 86 in FIG. 8, is limited by an edge 88 on a wall 90 to which the pin portion 60 is abuttable. Turning of the post part 12 in the opposite direction around the axis 28, as indicated by the arrow 92, causes the pin leg 82 to abut to a surface 96 on the wall 90. The leg portion 58 cooperates with a corresponding wall 90′ in like fashion, with it being understood that the body 74 could be reversed by rotation around the axis 28 relative to the post part 12 and pin 52.

In this embodiment, the pin leg 82 is substantially straight and joined to the pin leg 54 through a curved bight portion 98. This particular configuration is not critical, so long as the chosen shape permits the described interaction between the pin 52 and quick release assembly 72.

With the described arrangement, the wall 90 becomes loosely captive between the pin legs 54, 82, thereby avoiding inadvertent shifting of the pin portion 60 off of the first surface 76 and shifting of the corresponding pin portion 58 off of the first surface 76′, so long as the pin 52 is maintained in its locked state.

With the pin 52 in its released state, the post part 12 and quick release assembly 72 can be relatively turned around the axis 28 to allow the pin portions 58, 60 to angularly shift from the first surfaces 76, 76′ to align over, and drop down against, the second surfaces 78, 78′, as a result of which the effective length of the shoring post 70 is reduced by the height of the step X between the surfaces 76, 76′; 78, 78′, thereby diminishing the compressive force produced between the surfaces 36, 38.

With the pin portions 58, 60 against the surfaces 78, 78′, angular movement of the pin 52 relative to the quick release assembly 72 is confined by a surface 100 on the wall 90′ and a separate, spaced surface 102 on a wall 104 upon which the first surface 76 is defined. The surfaces 100, 102 bound the surface 78 at angularly spaced locations. The pin 52 is confined angularly over the second surface 78′ by corresponding surfaces 100′, 102′.

Blocks 104, 104′ are defined on the body 74 at diametrically opposite locations. Exemplary block 104 has an exposed surface 106 defining a face to be impacted by an object to generate a force along a first line 108 that is generally orthogonal to the surface 106. A force imparted to the surface 106 along the first line 108 has a component that urges the quick release assembly 72 in a direction of the arrow 110 (FIG. 18) around the central axis 28. The surface 106, and the diametrically opposite surface 106′, project radially to outside of the post parts 12, 14 to be accessible, as to be struck by a hammer or other weighted object 112. Through this action, the pin 52 and quick release assembly 72 can be instantaneously changed from their first operative relationship into their second operative relationship to reduce the compressive loading force produced by the shoring post 70.

With the above structure, the shoring post 70 can be installed as follows. With the pin 52 in its released state, the shoring post 70 can be placed in compression between the facing surfaces 36, 38 with the pin 52 and quick release assembly 72 in the first operative relationship. Thereafter, the pin 52 can be changed from the released state into the locked state by turning the pin 52 around the axis 84 to maintain the first operative relationship between the pin 52 and quick release assembly 72. The shoring post 70 will maintain this configuration to allow the appropriate task(s) to be performed.

Thereafter, to reset or disassemble the shoring post 70, the pin 52 is changed from its locked state into its released state, after which the pin 52 and quick release assembly 72 can be changed from their first operative relationship into their second operative relationship. As this occurs, the pin leg 54 changes angular alignment from over the first surfaces 76, 76′ to over the second surfaces 78, 78′. Residual compressive forces in the shoring post 70 cause the pin leg 54 to shift downwardly, thereby incrementally changing the effective length of the shoring post 70 by the distance X, which may be on the order of ½ inch. This distance X may be greater or less depending upon the particular application.

As noted above, with the shoring post 70 placed in compression, the quick release assembly 72 is squeezed captively between the pin leg 54 and the quick release assembly 72. Thus, a significant impact force produced, as through a hammer, may be required to turn the quick release assembly 72 relative to the pin 52.

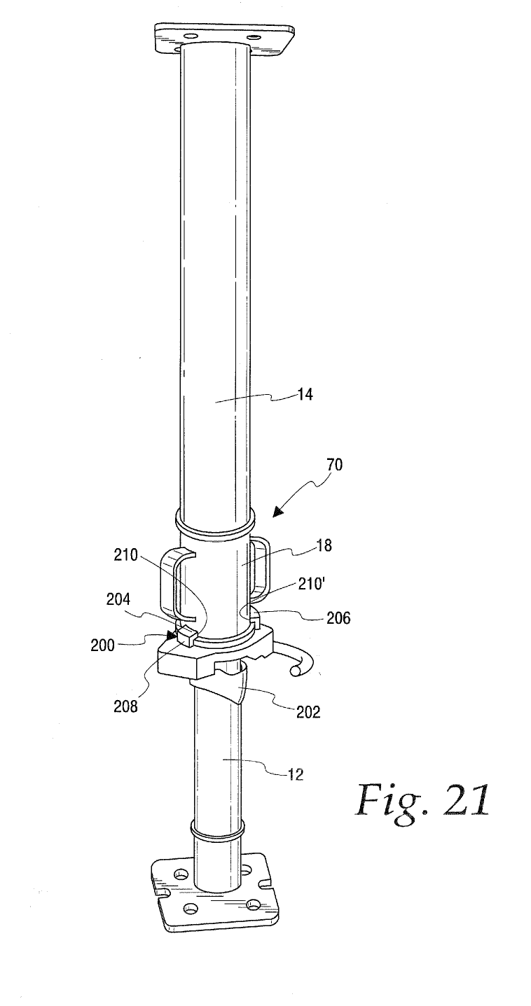

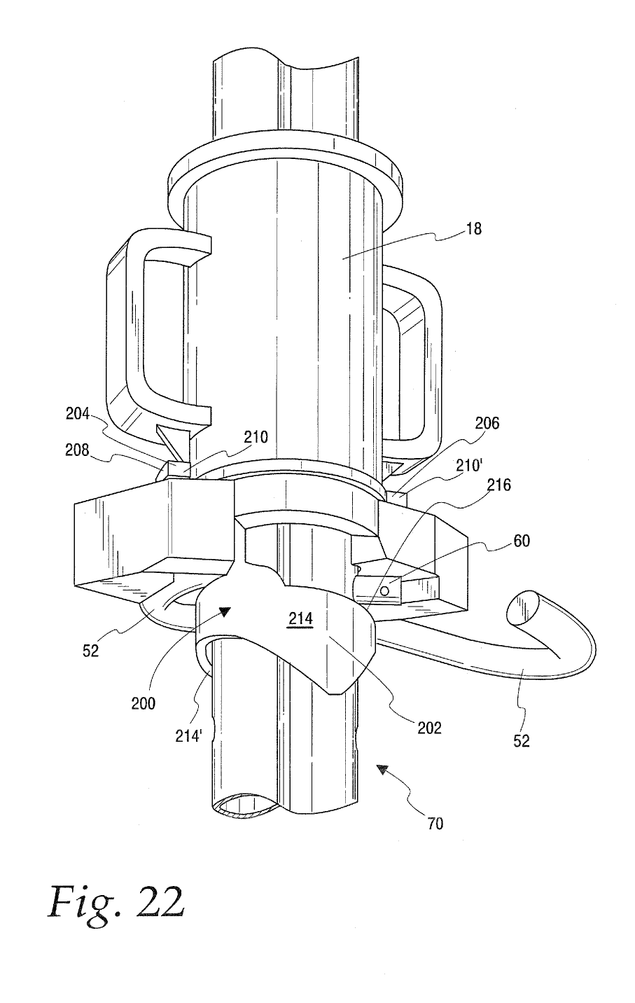

In some applications, the shoring post 70 may be on the order of fourteen feet in length. With the depicted configuration, the extension sleeve 18 is at a height that it is not reachable to be turned by an individual standing at ground level. To address this problem, the shoring post 70 is shown in FIGS. 21 and 22 to be inverted from the FIG. 4 orientation so that the extension sleeve 18 is closer to the bottom of the shoring post 70 than the top thereof. The basic length adjustment and quick release are effected as described above; however, provision must be made to keep the post parts 12, 14 from separating.

For this purpose, a retainer assembly 200 is incorporated. The retainer assembly 200 comprises a body 202 with diametrically oppositely located supporting arms 204, 206, each with a generally “L” shape. Exemplary supporting arm 204 has a vertical leg 208 and a horizontal leg 210 that bears against a radially enlarged, annular flange 212 on the extension sleeve 18. The leg 208, and a like leg 208′ on the supporting arm 206, cooperatively block downward movement of the body 202 relative to the extension sleeve 18.

The body 202 has at least one, and preferably two, locking extensions 214, 214′ each defining a bearing edge 216 (for exemplary blocking extension 214) that abuts to the projecting portion 60 of the pin 52. The other projecting portion 58 (not shown) cooperates with the blocking extension 214′ in like fashion.

Through this arrangement, with the shoring post in the orientation in FIGS. 21 and 22, the post part 12 is prevented from sliding unrestrained downwardly relative to the post part 14 as would otherwise allow the post part 12 to eventually separate from the post part 14.

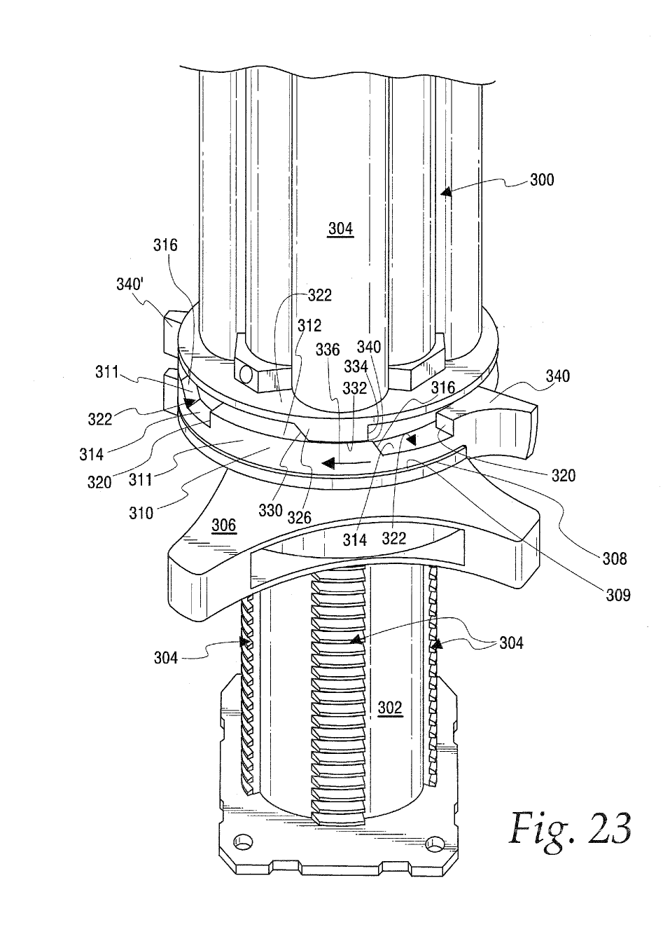

In FIG. 23, a further modified form of shoring post is shown at 300. The shoring post 300 has a first post part 302 that slides within a second post part 304. The post parts 302, 304 are configured complementarily in cross section so that they are keyed against relative turning around a vertical central axis from the shoring post 300.

In this embodiment, the post part 302 has circumferentially spaced rows of threads 304 that are cooperatively engaged by a star-shaped, threaded extension nut 306 that is turned relative to the post part 302 around the central shoring post axis to change its vertical location upon the post part 302.

The extension nut 306 has an associated support plate 308 with an upper surface 309 upon which a quick release assembly 310, corresponding to the quick release assembly 72, bears. The quick release assembly 310 has an annular body portion with circumferentially spaced steps 311, each with an upper support surface 312. Between adjacent steps 311, a lower support surface 314 is defined. A ramp surface 316 transitions between the upper support surface 312 on one step 311 and a lower support surface 314, with the lower support surface 314 extending to a blocking surface 320 on the adjacent step 311. Receptacles 322 are thus formed, each bounded by a ramp surface 316, a lower support surface 314, and a blocking surface 320, and located in spaced relationship around the circumference of the annular body portion.

The post part 304 has a base component 322 with extensions 326 that are each complementary in shape to the receptacles 322, with a plurality of the extensions 326 preferably each cooperating with a receptacle 322 in like fashion. More specifically, each extension 326 has a ramp surface 330, a lower support surface 332, and a blocking surface 334. By turning the quick release assembly 310 in the direction of the arrow 336, the ramp surfaces 316, 330 coincide and progressively guide each extension 326 downwardly into its respective receptacle 322, as an incident of which the post part 304 moves downwardly an increment corresponding to the depth of the receptacles 322.

Diametrically opposite blocks 340, 340′ are provided and correspond generally in structure and function to the blocks 104, 104′ previously described.

By turning the extension nut 306, the effective length of the shoring post 300 can be selected with the extension 326 angularly aligned to be supported upon the upper support surfaces 312, as shown in FIG. 23. The blocks 340, 340′ can then be impacted to turn the quick release assembly 310, thereby to cause the extensions 326 to move into the receptacles 322 and incrementally shorten the shoring post 300, as to facilitate its removal.

The foregoing disclosure of specific embodiments is intended to be illustrative of the broad concepts comprehended by the invention.

1. A shoring post comprising:
first and second post parts that are slidable guidingly relative to each other along a lengthwise line to cooperatively define a variable effective length;
a quick release assembly;
a movable pin that is extended into the first post part to an operative position wherein the pin abuts to the quick release assembly to limit movement of the first post part in one lengthwise direction relative to the second post part,
the quick release assembly comprising: a) at least a first surface against which the pin bears with the pin and quick release assembly in a first operative relationship; and b) at least a second surface against which the pin bears with the pin and quick release assembly in a second operative relationship,
the first and second surfaces spaced from each other along the lengthwise line; and
the shoring post further comprising at least one repositionable member that is changeable selectively between: a) a locked state wherein the at least one repositionable member prevents the pin and quick release assembly from changing from the first operative relationship into the second operative relationship; and b) a released state wherein the pin and quick release assembly can be changed from the first operative relationship into the second operative relationship.

2. The shoring post according to claim 1 wherein the first and second parts comprise tubular components that are telescopingly engaged, one within the other.

3. The shoring post according to claim 1 wherein the at least one repositionable member comprises the pin.

4. The shoring post according to claim 3 wherein the pin has a “C” shape.

5. The shoring post according to claim 3 wherein the pin has a body that moves as one piece, the body comprising: a) a first leg that extends into the first post part and abuts to the quick release assembly to thereby limit movement of the first post part in the one lengthwise direction relative to the second post part; and b) a second leg that abuts to the quick release assembly with the pin in the locked state to thereby prevent the pin and quick release member from changing from the first operative relationship into the second operative relationship.

6. The shoring post according to claim 5 wherein the first leg has a length with a central axis and the pin is changed between the locked and released states by moving around the central axis of the first leg.

7. The shoring post according to claim 1 wherein the at least first and second surfaces are substantially flat and reside in planes that are substantially parallel to each other and orthogonal to the lengthwise line.

8. The shoring post according to claim 1 wherein the shoring post has a central axis parallel to the lengthwise line and the quick release assembly comprises a body that is movable as one piece relative to the first and second post parts around the central axis of the shoring post.

9. The shoring post according to claim 8 wherein the body defines the first surface and a diametrically opposite surface, the pin bearing against both the first and diametrically opposite surfaces with the pin and quick release assembly in the first operative relationship.

10. The shoring post according to claim 8 wherein the body defines the second surface and a diametrically opposite surface, the pin bearing against both the second and diametrically opposite surfaces with the pin and quick release assembly in the second operative relationship.

11. The shoring post according to claim 8 wherein the body has a shape that is symmetrical so that the body interacts with the pin in the operative position in the same manner with the body in each of: a) one angular position; and b) a second angular position turned relative to the pin through 180° around the central axis of the shoring post from the one angular position.

12. The shoring post according to claim 1 wherein the shoring post has a central axis parallel to the lengthwise line and the quick release assembly comprises spaced walls bounding the second surface that abut to the pin with the pin and the quick release assembly in the second operative relationship to confine opposite relative angular movement between the first post part and quick release assembly around the central axis.

13. The shoring post according to claim 1 wherein the shoring post has a central axis parallel to the lengthwise line and the quick release assembly comprises a wall that abuts to the pin with the pin and the quick release assembly in the first operative relationship to block angular movement of the first post part in one direction around the central axis relative to the quick release assembly.

14. The shoring post according to claim 13 wherein the pin comprises a body that is movable as one piece and the body abuts to the wall with the pin and the quick release assembly in the first operative relationship and the repositionable member in the locked state to thereby block angular movement of the first post part oppositely to the one direction relative to the quick release assembly.

15. The shoring post according to claim 1 wherein the shoring post has a central axis parallel to the lengthwise line and the quick release assembly comprises a surface with a face to be impacted by a force along a first line and a force imparted to the face along the first line has a component that urges the quick release assembly in movement around the central axis.

16. The shoring post according to claim 15 wherein the quick release assembly comprises a body that moves as one piece around the central axis and the body comprises a block upon which the face is defined.

17. The shoring post according to claim 1 wherein the face projects radially to outside of the first and second post parts.

18. A method of using a shoring post, the method comprising the steps of:
providing a shoring post as in claim 6;
with the pin in the released state, placing the shoring post in compression between facing surfaces with the pin and quick release assembly in the first operative relationship;
with the pin and quick release assembly in the first operative relationship, changing the pin from the released state into the locked state by turning the pin around the central axis at the first leg; and
changing the pin from the locked state back into the released state; and
changing the pin and quick release assembly from the first operative relationship into the second operative relationship.

19. The method of using a shoring post according to claim 18 wherein the step of providing a shoring post comprises providing a shoring post with a central axis parallel to the lengthwise line and a quick release assembly comprising a body that is movable around the central axis as one piece.

20. The method of using a shoring post according to claim 19 wherein the step of changing the pin and quick release assembly from the first operative relationship into the second operative relationship comprises producing a sharp impact force upon the body of the quick release assembly that causes the body of the quick release assembly to turn around the central axis.

21. The shoring post according to claim 1 further comprising a retainer assembly that cooperates with the second post part to limit movement of the first post part relative to the second post part in a direction opposite to the one lengthwise direction.

22. The shoring post according to claim 21 wherein there is an extension sleeve on the second post part and the retainer assembly cooperates with the extension sleeve on the second post part.

23. The shoring post according to claim 22 wherein the retainer assembly comprises a horizontal leg that bears against the extension sleeve.

24. The shoring post according to claim 23 wherein the retainer assembly comprises a supporting arm against which the pin bears to block movement of the first post part relative to the second post part in the direction opposite to the one lengthwise direction.

25. The shoring post according to claim 1 wherein the shoring post has a lengthwise axis and the first and second post parts are keyed against relative turning around the lengthwise axis.
